(19) United States
(12) Patent Application Publication
(10) Pub. No.: US 2014/0356669 A1
(43) Pub. Date: Dec. 4, 2014

(54) BATTERY MODULE

(71) Applicants: ROBERT BOSCH GMBH, Stuttgart (DE); SAMSUNG SDI CO., LTD., Yongin-si (KR)

(72) Inventor: Jang-Gun AHN, Yongin-si (KR)

(73) Assignees: ROBERT BOSCH GMBH, Stuttgart (DE); SAMSUNG SDI CO., LTD., Yongin-si (KR)

(21) Appl. No.: 14/189,146

(22) Filed: Feb. 25, 2014

(30) Foreign Application Priority Data
May 29, 2013 (KR) 10-2013-0061183

(51) Int. Cl. H01M 10/42; H01M 2/10; H01M 10/48

(52) U.S. Cl. CPC H01M 10/425; H01M 10/48; H01M 2/1077; H01M 2220/20; H01M 2010/4271
USPC 429/90; 429/121

(57) ABSTRACT

A battery pack includes a second case coupled to a first case. The first case has an opening and includes a battery module, and the second case covers the opening in the first case. The second case moves between open and closed states relative to the opening in the first case. A surface of the battery module includes a power circuit is aligned with the opening in the first case and is exposed when the second case is in the open state. High current terminals of the battery module may also be exposed when the second case is opened. Wires passing through holes in the first case may be removably coupled to the high current terminals.

### CROSS-REFERENCE TO RELATED APPLICATION

Korean Patent Application No. 10-2013-0061183, filed on May 29, 2013, and entitled “Battery Module,” is incorporated by reference herein in its entirety.

### BACKGROUND

1. Field

One or more embodiments disclosed herein relates to a battery pack.

2. Description of the Related Art

A high-power battery module using a non-aqueous electrolyte with high energy density has recently been developed. The high-power battery module is configured as a large-capacity battery module, which is manufactured by connecting a plurality of battery cells in series for use in driving motors of devices requiring high power, e.g., electric vehicles and the like. Because electric vehicles and other applications operate a high voltage, safety and proper operation of the battery pack may be a concern.

### SUMMARY

In accordance with one embodiment, a battery pack includes at least one battery module including one or more current terminals, a first case including the battery module and having an opening, a second case to cover the opening of the first case, a power circuit in and electrically disconnected from the first case, a first connecting portion adjacent to the power circuit, a second connecting portion coupled between the first connecting portion and the second case, and a connector to electrically connect the one or more current terminals and the power circuit. The first connecting portion, the second connecting portion, and the power circuit are aligned with the opening in the first case and are covered by the second case.

Also, the connector may includes a reverse U-shaped conductive pin, and the second connecting portion may surround the connector.

Also, a first end of the second connecting portion may be opened to expose the connector, and the second connecting portion may be coupled to the first connecting portion. A hinge may couple an inner surface of the second case to a second end of the second connecting portion.

Also, the battery pack may include a guide portion coupled to the second case, wherein the guide portion is spaced from an edge of and protrudes towards the first case. A boundary portion may be around the opening of the first case, wherein the boundary portion has a stepped surface and wherein the second case is mounted on the boundary portion. The guide portion may be inserted into the opening of the first case.

Also, a boundary portion may be round the opening of the first case, a first fastening portion provided to the boundary portion, and a second fastening portion in the second case and corresponding to the first fastening portion.

Also, a handle may be coupled to the second case, wherein the handle and the second connecting portion are on opposing surfaces of the second case. The handle may have at least one curved shape protruding from the second case. The first case may be made of an opaque material, and the second case may be made of a transparent material.

Also, the first case include a base to accommodate the battery module, and a cover coupled to the base. The base may include one or more through-holes, and one or more wires may pass through respective ones of the through-holes to electrically connect to the one or more current terminals of the battery module.

Also, the cover may include the opening in the first case, and the one or more current terminals may be aligned with the opening in the cover.

Also, the power circuit may be electrically connected to the battery module, and the power circuit may transfer to the battery module information indicating a state of the connector.

In accordance with another embodiment, a battery pack includes a first case including an opening; a second case coupled to the first case; and a battery module within the first case and covered by the second case, wherein the second case moves between open and closed states relative to the opening in the first case, and wherein a surface of the battery module which includes a power circuit is aligned with the opening in the first case and is exposed when the second case is in the open state.

Also, one or more current terminals may be coupled to the battery module, wherein the one or more current terminals are aligned with the opening in the first case and are exposed when the second case is in the open state.

Also, a first connector may physically couple the second case to the first case, and a second connector may electrically couple one or more current terminals of the battery module to the power circuit, wherein the second connector is located within at least a portion of the first connector.

Also, the power circuit may be located between the first and second connectors and a surface of the battery module. The first case may include at least one hole, one or more wires may pass through the at least one hole, and the one or more wires may be removably coupled to current terminals of the battery module.

### BRIEF DESCRIPTION OF THE DRAWINGS

Features will become apparent to those of ordinary skill in the art by describing in detail exemplary embodiments with reference to the attached drawings in which:

FIG. 1 illustrates one embodiment of a battery pack;

FIG. 2 illustrates an exploded view of the battery pack of FIG. 1;

FIG. 3A illustrates an example of a second case of FIG. 2;

FIG. 3B illustrates a bottom view of the second case of FIG. 3A;

FIG. 4 illustrates the second case and a power circuit in FIG. 2;

FIG. 5 illustrates a coupled state of the first and second case;

FIG. 6 illustrates another embodiment of a battery pack;

FIG. 7 illustrates a sectional view taken along line I-I of FIG. 6; and

FIG. 8 illustrates a coupled state of first and second cases in a battery pack.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

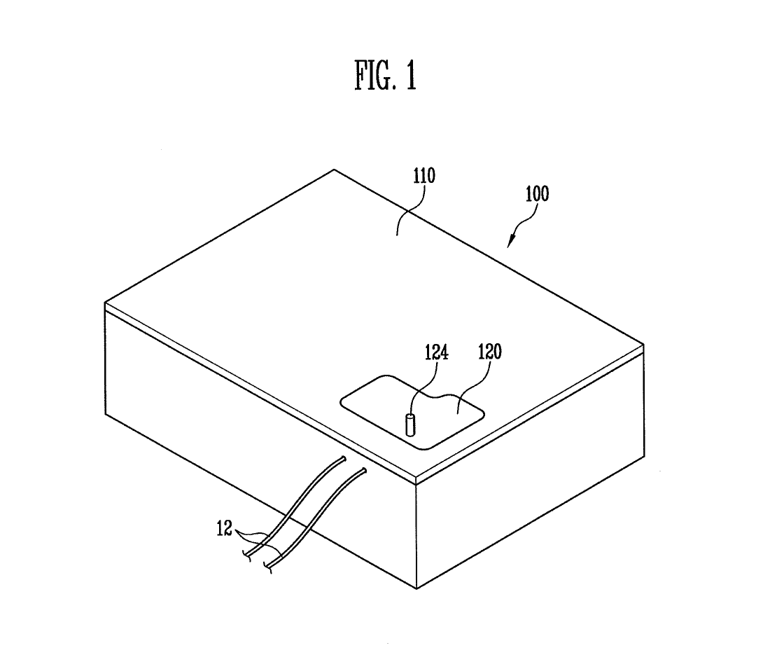

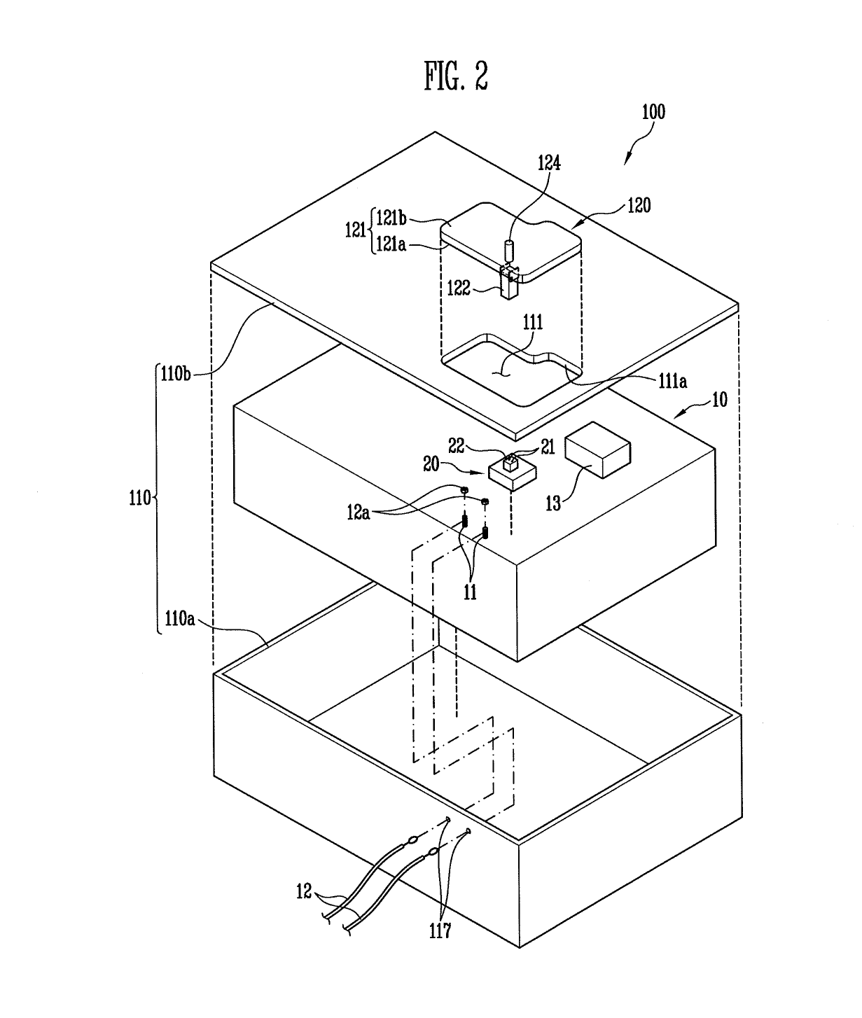

FIG. 1 illustrates a perspective view of one embodiment of a battery pack 100, and FIG. 2 illustrates an exploded perspective view of the battery pack of FIG. 1.

Referring to FIGS. 1 and 2, the battery pack 100 includes one or more battery modules 10, a first case 110, and a second case 120. Each battery module is configured to have a high current terminal 11. The first case 110 is configured to accommodate the battery module 10 and has an opening 111 at one side thereof. The second case 120 is configured to cover the opening 111 of the first case 110.

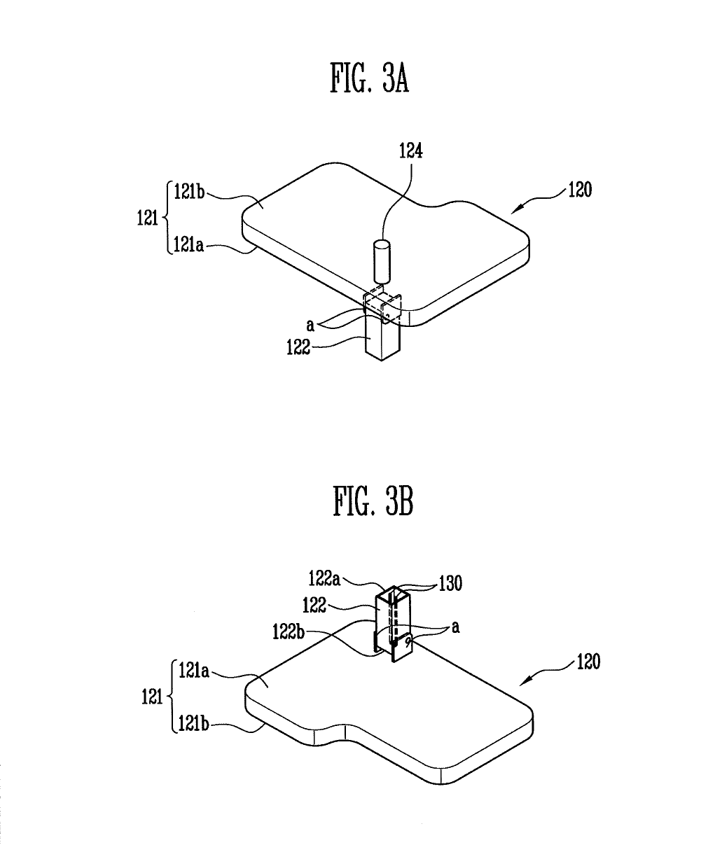

In addition, a power circuit 20 is mounted within the first case 110 and is electrically disconnected from the first case 110. A first connecting portion 22 is provided adjacent to the power circuit 20. A second connecting portion 122 is physically coupled to the first connecting portion 22 and is provided within the second case 120. A connector 130 (see FIG. 3B) is also provided to allow electric current to be applied to the power circuit 20. The connector may be provided, for example, at one side of the second connecting portion 122.

In one embodiment, the battery module 10 includes a plurality of electrically connected battery cells. The battery cells may be connected in series or parallel to one another. Each battery cell may be reversibly charged and/or discharged. The number and manner of connection of the battery cells constituting the battery module 10 may vary in different embodiments.

A battery management system (BMS) 13 may be provided at a predetermined location (e.g., one side) of the battery module 10. The BMS 13 may control the electrical flow of the battery cell in order to efficiently use energy generated in the battery cell. The high current terminals 11 have different polarities. The battery cells may be connected in series or parallel to an external device through the high current terminals. For example, the plurality of battery cells constituting the battery module 10 may be electrically connected to the high current terminals 11, and the high current terminals 11 may be connected to an external electronic device to be powered by the battery module 10. The high current terminals, therefore, may serve as a passage through which electrical energy generated in the battery cells is transferred to the external electronic device.

The battery module 10 may be provided inside the first case 110, and the opening 111 may be provided at one side of the first case 110. In one embodiment, the first case 110 includes an accommodating portion (or base) 110a configured to accommodate the battery module 10 therein and a cover 110b configured to cover one side of the accommodating portion 110a. In this case, the opening 111 may be provided in the cover 110b. For example, the accommodating portion 110a and the cover 110b may be individually manufactured and the coupled together, or may be integrally manufactured. The opening 111 may be provided at a position corresponding to the high current terminals 11. Thus, the position of the high current terminals 11 of the battery module 10 can be confirmed through the opening 111 at an upper portion of the first case 110.

One or more through-holes 117 are provided in the accommodating portion 110a, for example, at a position adjacent to the opening 111 provided in the cover 110b. One or more wires 12 may be electrically connected to corresponding ones of the high current terminals 11 of the battery module 10, by passing through the through-holes 117. For example, the through-holes 117 may be provided at a side surface of the accommodating portion 110a facing the high current terminals 11. The wires 12 may be removably connected to the high current terminals 11, for example, by being inserted into the accommodating portion 110a through the through-holes 117. After being connected to the high current terminals 11, the wires 12 may be fixed to the high current terminals 11, for example, by a fixing member 12a such as a nut. The fixing member, therefore allows the wires 12 to be firmly fixed to the high current terminals 11.

The power circuit 20 may be provided adjacent to the high current terminals 11. The power circuit 20 may be mounted in the first case 110 so as to be electrically disconnected from the first case 110. The power circuit 20 may be provided at a position corresponding to the opening 111. Also, the first connecting portion 22 protruding in an outward direction may be provided to the power circuit 20.

The first connecting portion 22 may include a disconnecting portion 21 that is electrically disconnected from the power circuit 20. The power circuit 20 may be electrically connected to the battery module 10 and may transfer information indicative of a state of the connector 130. For example, the power circuit 20 may transfer, to the BMS 13, information indicative of whether the power circuit 20 is connected to the connector 130. The BMS 13 controls current or voltage of the battery cells according to the information transferred from the power circuit 20.

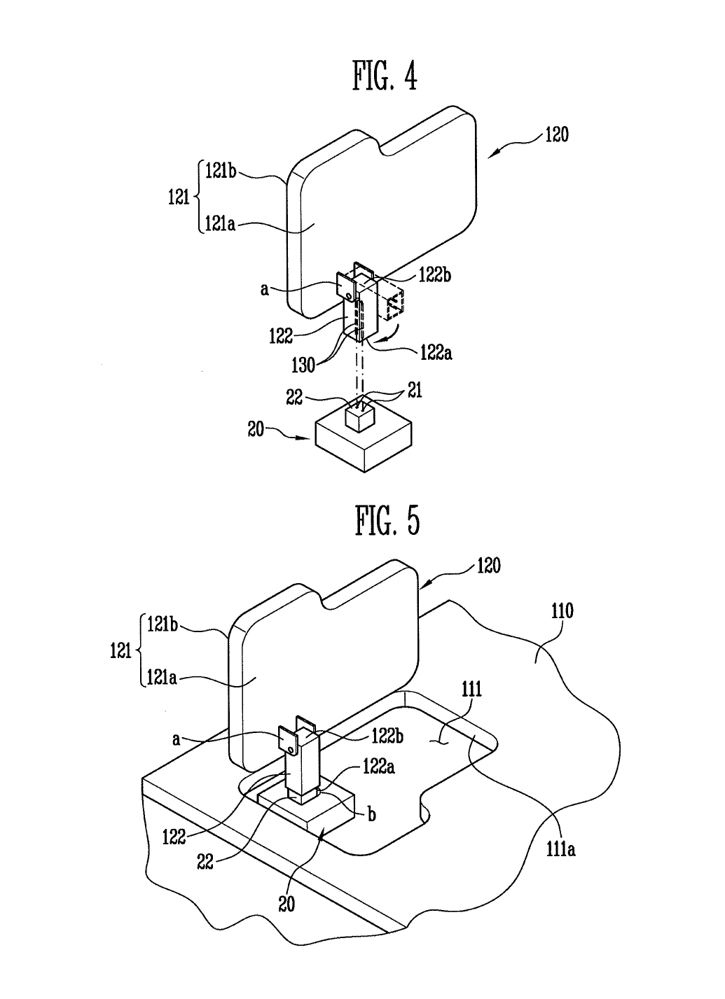

FIG. 3A illustrates a perspective view of the second case 120 of FIG. 2, FIG. 3B illustrates a perspective view showing the second case 120 of FIG. 3A viewed from the bottom thereof, and FIG. 4 illustrates a perspective view showing the second case 120 and the power circuit shown in FIG. 2.

Referring to FIGS. 3A to 4, the second case 120 may include a base portion 121 formed in a shape corresponding to that of the opening of the first case, and a second connecting portion 122 provided toward the inside of the first case 121 from the base portion 121. A connector 130 may be provided in the second connecting portion 122.

Also, the second case 120 may include a handle portion 124 on a surface 121b opposite to a surface 121a on which the second connecting portion 122 is provided. For example, the second connecting portion 122 may be connected to the first surface 121a of the base portion 121, and the handle portion 124 may be provided on the second surface 121b that is a surface opposite to the first surface 121a of the base portion 121. The handle portion 124 can facilitate the movement (e.g., moving between open and closed states) of the second case 120. The handle portion 124 can also facilitate the attachment or detachment of the second case 120.

The connector 130 may include, for example, a reverse U-shaped conductive pin, and the second connecting portion 122 may be provided to surround the connector 130. One end 122a of the second connecting portion 122 is opened to expose the connector 130. The second connecting portion 122 may be coupled to the first connecting portion 22. The first connecting portion 22 is formed in a shape corresponding to that of the second connecting portion 122, so that the first and second connecting portions 22 and 122 can be physically coupled to each other. When the first and second connecting portions 22 and 122 are coupled to each other, the connector 130 and the disconnecting portion 21 can be coupled together. The connector 130 enables an electric current to be applied to the power circuit 20.

In a high-voltage battery pack, high voltage flows in the high current terminals electrically connected to an external device and corresponding wires are provided to the high current terminals. Therefore, the high current terminal is not exposed to the outside of the battery pack due to a problem of safety. Also, the high current terminals and the wires may be separated from each other when a problem occurs in the battery pack or the external device, or when a safety inspection is performed on a battery module. Therefore, it may be difficult to completely seal the high current terminals. Thus, the high current terminals are not exposed to the outside of the battery pack, and the high current terminals and the wires may be separated from each other when required. Accordingly, the high current terminals may be stably sealed and also may be safely separated from the wires when required.

Thus, in at least this embodiment, the battery pack may be provided so that interlocking can be performed through electrical connection at a portion adjacent to the high current terminals, and the high current terminals can be stably sealed when current flows in the high current terminals. Also, the high current terminals can be easily separated, thereby improving the safety and lifespan of the battery pack.

In a case where the second case is mounted to the first case, the second case may be movably or pivotally fixed by coupling the second connecting portion of the second case to the first connecting portion. Also, the connector may be connected to the disconnecting portion so that electric current can be applied to the power circuit.

The power circuit is connected to the BMS provided in the battery module so as to transfer information indicative of whether electric current is applied to the power circuit. That is, the coupling between the first and second connecting portions and the connection between the connector and the disconnecting portion are performed together. Thus, in a case where the second case is mounted to the first case, electric current is applied to the power circuit by the connector, and the power circuit transfers, to the BMS, information indicative of the sate in which the electric current is applied thereto.

On the other hand, in a case where the second case is detached from the first case, the connector is separated so that the power circuit is disconnected. In this case, the power circuit transfers, to the BMS, information indicating the state in which the power circuit is disconnected. That is, in a case where electric current is applied to the power circuit, the BMS normally operates the battery module. In a case where the power circuit is disconnected, the BMS disconnects the flow of current in the battery module so that the battery pack can be stably used.

FIG. 5 illustrates a view schematically showing a state in which the first and second cases are coupled to each other. Referring to FIGS. 5 and 5, the other end 122b of the second connecting portion 122 may have a hinge structure a, and may be connected to an inner surface of the second case 120. The second connecting portion 122 is connected to the second case 120 by the hinge structure a, and thus can be reciprocated, or otherwise moved, from a position vertical to the base portion 121 of the second case 120 to a position, for example, which is parallel to the base portion 121 of the second case 120.

Accordingly, when the second case 120 is mounted to the first case 110, the second connecting portion 122 is positioned in parallel to the second case 120. Also, the first and second connecting portions 22 and 122 may then be coupled to each other. Subsequently, the second case 120 is mounted to the first case 110, using the hinge structure a, so that the opening 111 of the first case 110 can be easily covered.

As described above, in a case where the connector 130 is provided to the second case 120, and interlocking is performed by allowing electric current to be applied to the power circuit 20 by the connector 130, the connector 130 is connected to the power circuit 20 at a predetermined position of the power circuit 20. In a case where interlocking is not normally performed due to erroneous insertion of the connector 130, the safety of the battery pack may be problematic. In this embodiment, the hinge structure a is provided to the second case 120, so that the connector 130 can be easily connected to the disconnecting portion 21 of the power circuit 20. Further, the first and second connecting portions 22 and 122 are physically coupled to each other, so that the connector 130 and the disconnecting portion 21 can be stably connected to each other.

In a case where the second case 120 is opened to about 90 degrees or more with respect to the first case 110 in the state in which the connector 130 and the disconnecting portion 21 are connected to each other, the second connecting portion 122 inserted into the first connecting portion 22 may be extracted by a predetermined distance b. Thus, the connector 130 is detached by being spaced apart from the disconnecting portion 21, and the power circuit 20 is disconnected. Accordingly, it is possible to perform interlocking of the battery pack.

In one example arrangement, the first case 110 may be made of an opaque material and the second case 120 may be made of a transparent material. When the first case 110 is made of the opaque material, the inside of the battery pack is not viewable from outside the battery pack. On the other hand, when the second case 120 is made of the transparent material, the second connecting portion 122 can be easily coupled to the first connecting portion 22.

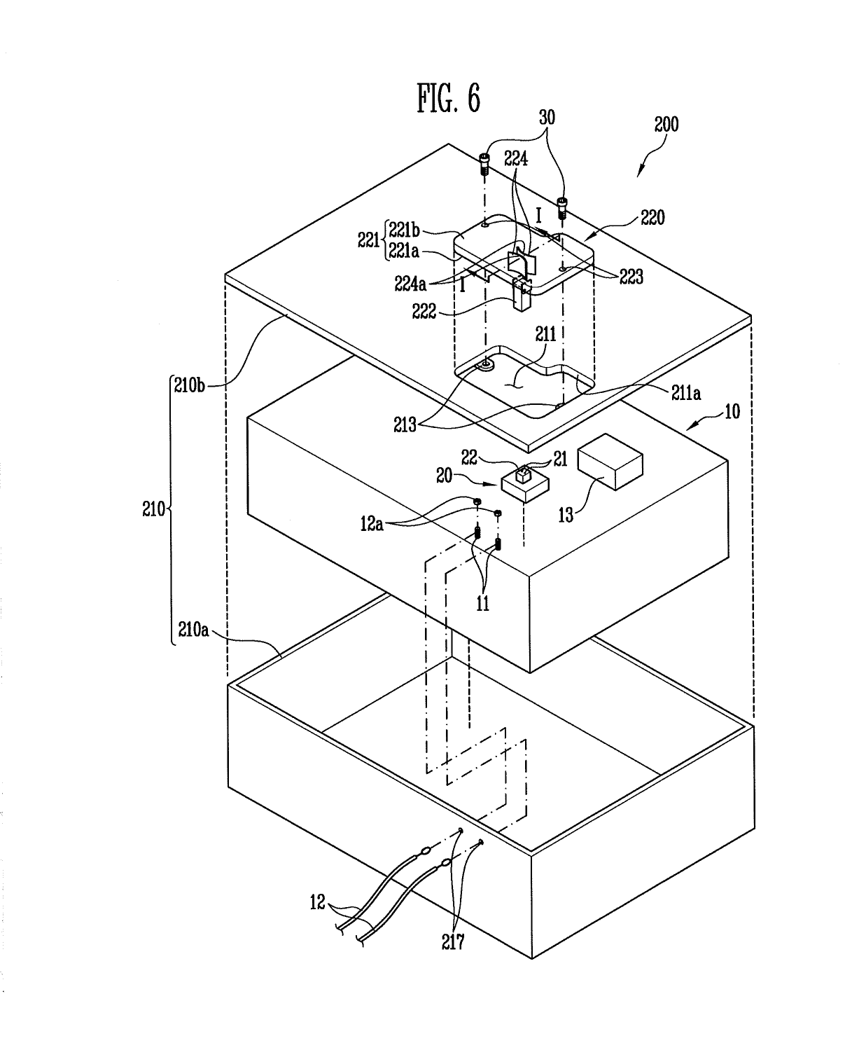

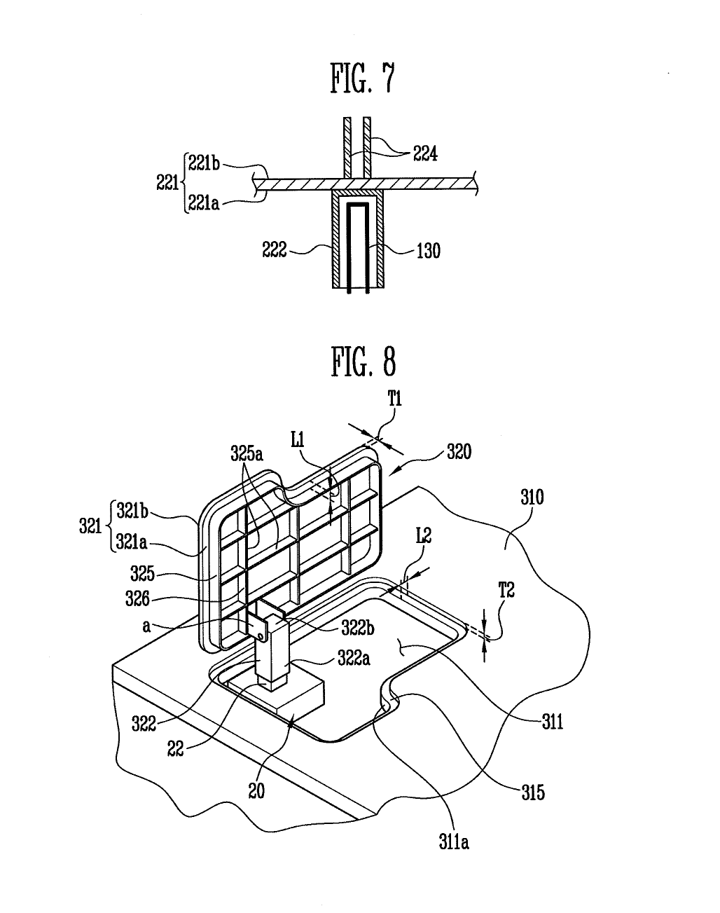

FIG. 6 illustrates an exploded perspective view of another embodiment of a battery pack 200, and FIG. 7 illustrates a sectional view taken along line I-I of FIG. 6.

Referring to FIGS. 6 and 7, the battery pack 200 includes a first case 210 and a second case 220 configured to cover an opening 211 of the first case 210. A power circuit 20 having a disconnecting portion 21, that is an electrically disconnected portion, may be mounted inside the first case 210. A first connecting portion 22 surrounding the disconnecting portion 21 is provided to the power circuit 20. The first connecting portion 22 may be physically coupled to a second connecting portion 222 of the second case 220. A connector 130 provided inside the second connecting portion 222 is coupled to the disconnecting portion 21, so that electric current can be applied to the power circuit 20.

A boundary portion 211a may be provided around the opening 211 of the first case 210. A first fastening portion 213 may be provided to the boundary portion 211a, and a second fastening potion 223 corresponding to the first fastening portion 213 may be provided to the second case 220. One or more holes are provided in each of the first and second fastening portions 213 and 223. Each hole may receive a separate fastening member 30, e.g., a bolt-nut, stud or the like, so that the first and second cases 210 and 220 can be firmly fixed to each other.

The second case 220 may include a handle portion 224, which, for example, may be provided on a surface 221b opposite to a surface 221a on which the second connecting portion 222 is provided.

The second case 220 may include a base portion 221, the second connecting portion 222, and the handle portion 224. The second connecting portion 222 is provided on the first surface 221a of the base portion 221. The handle portion 224 may be provided on the second surface 221b, which, for example, may be a surface opposite to the first surface 221a.

The handle portion 224 may be at a position corresponding to the second connecting portion 222. For example, the handle portion 224 may have the shape of a pair of parabolas or curved surfaces protruding from the second case 220. In this case, the pair of parabolas or curved surfaces may be provided so that their protruding portions 224a face each other. The handle portion 224 enables the second case 220 to be easily separated from the first case 210.

The second connecting portion 222 may be separated from the first connecting portion 22, and the connector 130 can also be separated with the second connecting portion 220. Because the position of the handle portion 224 is provided to correspond to the first connecting portion 22, the second case 220 can be safely separated without any electrical short circuit. Further, the grip property of the handle portion 224 may be improved because of its shape, to thereby allow the second case 220 to be easily separated with a small force.

FIG. 8 illustrates a view schematically showing a state in which first and second cases are coupled to each other in a battery pack according to another embodiment. Referring to FIG. 8, when the second case 320 covers an opening 311 of the first case 310, a second connecting portion 322 provided to the second case 320 may be physically coupled to a first connecting portion 22 of a power circuit 20 mounted in the first case 310. The second connecting portion 322 is connected to the second case 320 by a hinge structure a, and thus can be freely reciprocated. Accordingly, the second case 320 can be easily mounted to the first case 310.

The second case 320 may have a guide portion 325 spaced apart from the first case 310 at an edge of the second case 320 to protrude toward the first case 310. A boundary portion 311a is provided around the opening 311 of the first case 310. The boundary portion 311a may be provided to have a step difference, and the second case 320 may be mounted on the boundary portion 311a. In this case, the guide portion 325 may be provided corresponding to the opening 311 so as to be inserted into the opening 311.

The second case 320 may include a base portion 321, the second connecting portion 322, and the guide portion 325. The second connecting portion 322 and the guide portion 325 are provided on a first surface 321a of the base portion 321. In this case, the guide portion 325 may be provided at an edge of the base portion 321 to be spaced apart from the first case 310 at a first lateral length L1.

The first case 310 includes a stepped portion 315 having a surface lower than surrounding surfaces at the boundary portion 311a. The second lateral length L2, that is a width of the stepped portion 315, may be provided to correspond to the first lateral length L1. Thus, the guide portion 325 may be inserted to correspond to the opening 311, and the stepped portion 315 can stably support the second case 320.

In the second case 320, the first longitudinal length T1, that is a thickness of the base portion 321, may be provided to correspond to a second longitudinal length T2. This may be further stepped than surrounding surfaces at the boundary portion 311a. Thus, after the opening 311 of the first case 310 is covered with the second case 320, the second case 320 can be provided to form a flat surface with surroundings, without being further protruded than the surroundings or recessed inward.

For example, the section of the guide portion 325 may be formed in a closed curve along the edge of the second case 320, and a plurality of ribs 325a connecting inner surfaces of the guide portion 325 in a lattice form may be provided inside the guide portion 325. The guide portion 325 and the ribs 325a firmly maintain the second case 320, so that it is possible to prevent the second case 320 from being distorted by the use of the battery pack for a long time of period.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
at least one battery module including one or more current terminals;
a first case including the battery module and having an opening;
a second case to cover the opening of the first case;
a power circuit in and electrically disconnected from the first case;
a first connecting portion adjacent to the power circuit;
a second connecting portion coupled between the first connecting portion and the second case; and
a connector to electrically connect the one or more current terminals and the power circuit, wherein the first connecting portion, the second connecting portion, and the power circuit are aligned with the opening in the first case and are covered by the second case.

2. The battery pack as claimed in claim 1, wherein:
the connector includes a reverse U-shaped conductive pin, and
the second connecting portion surrounds the connector.

3. The battery pack as claimed in claim 1, wherein:
a first end of the second connecting portion is opened to expose the connector, and
the second connecting portion is coupled to the first connecting portion.

4. The battery pack as claimed in claim 3, further comprising:
a hinge to couple an inner surface of the second case to a second end of the second connecting portion.

5. The battery pack as claimed in claim 1, further comprising:
a guide portion coupled to the second case,
wherein the guide portion is spaced from an edge of and protrudes towards the first case.

6. The battery pack as claimed in claim 5, further comprising:
a boundary portion around the opening of the first case, and
wherein the boundary portion has a stepped surface and wherein the second case is mounted on the boundary portion.

7. The battery pack as claimed in claim 6, wherein the guide portion is inserted into the opening of the first case.

8. The battery pack as claimed in claim 1, further comprising:
a boundary portion around the opening of the first case;
a first fastening portion provided to the boundary portion; and
a second fastening portion in the second case and corresponding to the first fastening portion.

9. The battery pack as claimed in claim 1, further comprising:
a handle coupled to the second case,
wherein the handle and the second connecting portion are on opposing surfaces of the second case.

10. The battery pack as claimed in claim 9, wherein the handle has at least one curved shape protruding from the second case.

11. The battery pack as claimed in claim 1, wherein:
the first case is made of an opaque material, and
the second case is made of a transparent material.

12. The battery pack as claimed in claim 1, wherein the first case includes:
a base to accommodate the battery module, and
a cover coupled to the base.

13. The battery pack as claimed in claim 12, wherein:
the base includes one or more through-holes, and
one or more wires pass through respective ones of the through-holes to electrically connect to the one or more current terminals of the battery module.

14. The battery pack as claimed in claim 12, wherein:
the cover includes the opening in the first case, and
the one or more current terminals are aligned with the opening in the cover.

15. The battery pack as claimed in claim 1, wherein:
the power circuit is electrically connected to the battery module, and
the power circuit transfers information indicating a state of the connector to the battery module.

16. A battery pack, comprising:
a first case including an opening;
a second case coupled to the first case; and
a battery module within the first case and covered by the second case,
wherein the second case moves between open and closed states relative to the opening in the first case, and wherein a surface of the battery module which includes a power circuit is aligned with the opening in the first case and is exposed when the second case is in the open state.

17. The battery pack as claimed in claim 16, further comprising:
one or more current terminals coupled to the battery module,
wherein the one or more current terminals are aligned with the opening in the first case and are exposed when the second case is in the open state.

18. The battery pack as claimed in claim 16, further comprising:
a first connector to physically couple the second case to the first case, and
a second connector to electrically couple one or more current terminals of the battery module to the power circuit, wherein the second connector is located within at least a portion of the first connector.

19. The battery pack as claimed in claim 18, wherein the power circuit is located between the first and second connectors and a surface of the battery module.

20. The battery pack as claimed in claim 18, wherein:
the first case includes at least one hole,
one or more wires pass through the at least one hole, and
the one or more wires are removably coupled to current terminals of the battery module.
